(19) United States
(12) Patent Application Publication
(10) Pub. No.: US 2025/0292518 A1
(43) Pub. Date: Sep. 18, 2025

(54) INFORMATION PROCESSING APPARATUS AND INFORMATION PROCESSING METHOD FOR ENABLING TO NOTIFY USER OF POSSIBILITY OF CONTACT

(71) Applicant: CANON KABUSHIKI KAISHA, Tokyo (JP)

(72) Inventor: WATARU TAKAYANAGI, Kanagawa (JP)

(21) Appl. No.: 19/074,845

(22) Filed: Mar. 10, 2025

(30) Foreign Application Priority Data
Mar. 18, 2024 (JP) 2024-042166

(51) Int. Cl. G06T 19/00; G06F 3/16; G06T 5/50

(52) U.S. Cl. CPC G06T 19/006; G06F 3/165; G06T 5/50; G06T 2207/20221

(57) ABSTRACT

An information processing apparatus acquires a captured image capturing a real space including a first object and a second object. The information processing apparatus generates a virtual object. The information processing apparatus generates a composite image by combining the captured image and the virtual object. The information processing apparatus controls a display such that the composite image is displayed. In a first case where the virtual object is superimposed on a front side of the second object in a space expressed by the composite image, the information processing apparatus performs notification to a user in accordance with the distance between the first object and the second object.

### BACKGROUND OF THE INVENTION

### Field of the Invention

The present invention relates to an information processing apparatus and an information processing method for enabling to notify a user of the possibility of contact.

### Description of the Related Art

In an MR system, a hand masking technique is used, which expresses the front/back relationship between a CG object and a hand by occlusion, using an image of a real hand of the user. By using the hand masking technique, the user can recognize the front/back relationship between a virtual CG object and the hand of the user. The user can also feel as if the CG object were a real object that exists.

Japanese Patent Application Publication No. 2002-157606 discloses a technique related to a hand mask.

Japanese Patent Application Publication No. 2020-536305 discloses a technique to change the transmittance of a CG when a head mounted display (HMD) approaches the back of the CG.

In the hand masking technique, if a real hand of the user is located between a virtual CG object and the HMD, the CG object is masked in the shape of the hand, so that the user can see the real hand. This appears to the user as if the hand is on the front side of the CG object. If the real hand is behind the virtual CG object, the real hand is masked by the virtual CG object. This also makes the user feel as if the virtual CG actually exists.

However in the hand masking technique, the user cannot see the real object if the real object is hidden behind a virtual CG object. Therefore the user cannot recognize the distance between the real hand of the user and the real object, and cannot sense the possibility of contact.

### SUMMARY OF THE INVENTION

With the foregoing in view, it is an object of the present invention to provide a technique for enabling appropriately to notify the user of the possibility of contact in an MR technique.

An aspect of the present invention is an information processing apparatus including one or more processors and/or circuitry configured to: execute acquisition processing to acquire a captured image capturing a real space including a first object and a second object; execute generation processing to generate a virtual object; execute combining processing to generate a composite image by combining the captured image and the virtual object; execute display control processing to control a display such that the composite image is displayed; and execute notification processing to perform notification to a user in accordance with a distance between the first object and the second object in a first case where the virtual object is superimposed on a front side of the second object in a space expressed by the composite image.

An aspect of the present invention is an information processing method, including: an acquisition step of acquiring a captured image capturing a real space including a first object and a second object; a generation step of generating a virtual object; a combining step of generating a composite image by combining the captured image and the virtual object; a display control step of controlling a display such that the composite image is displayed; and a notification step of performing notification to a user in accordance with a distance between the first object and the second object in a first case where the virtual object is superimposed on a front side of the second object in a space expressed by the composite image.

Further features of the present invention will become apparent from the following description of exemplary embodiments with reference to the attached drawings.

### BRIEF DESCRIPTION OF THE DRAWINGS

FIG. 1 is a block diagram of an HMD system according to an embodiment;

FIG. 2 is a block diagram of an HMD system according to Embodiment 1;

FIGS. 3A to 3C are diagrams for describing an MR space according to Embodiment 1;

FIGS. 4A and 4B are diagrams for describing highlighting processing to display a hand according to Embodiment 1;

FIGS. 5A and 5B are diagrams for describing highlighting processing to display a hand according to Embodiment 1;

FIG. 6 is a flow chart of highlighting processing to display a hand according to Embodiment 1;

FIG. 7 is a block diagram of an HMD system according to Embodiment 2;

FIGS. 8A and 8B are diagrams for describing highlighting processing to display an operation member according to Embodiment 2;

FIGS. 9A and 9B are diagrams for describing highlighting processing to display a leg according to Embodiment 2;

FIG. 10 is a flow chart of highlighting processing according to Embodiment 2;

FIG. 11 is a block diagram of an HMD system according to Embodiment 3;

FIG. 12 is a flow chart of Example 1 of notification processing according to Embodiment 3;

FIG. 13 is a flow chart of Example 2 of notification processing according to Embodiment 3;

FIG. 14 is a flow chart of Example 3 of notification processing according to Embodiment 3;

FIGS. 15A and 15B are diagrams for describing Example 1 of notification processing according to Embodiment 3;

FIGS. 16A and 16B are diagrams for describing Example 2 of notification processing according to Embodiment 3; and

FIGS. 17A and 17B are diagrams for describing Example 3 of notification processing according to Embodiment 3.

### DESCRIPTION OF THE EMBODIMENTS

Each embodiment of the present invention will be described in detail with reference to the accompanying drawings. Contents common to each embodiment will be described first.

As a method for preventing contact (collision) with a real object hidden behind a virtual CG object and a real hand, there is a method of increasing the transmittance of the CG when the HMD approaches the real object, so that the user can see the real object. However if this method is used, a user experience (UX) problem may occur. For example, the sense of immersion as if the CG actually exists may be diminished, or interruption of the operation may be generated.

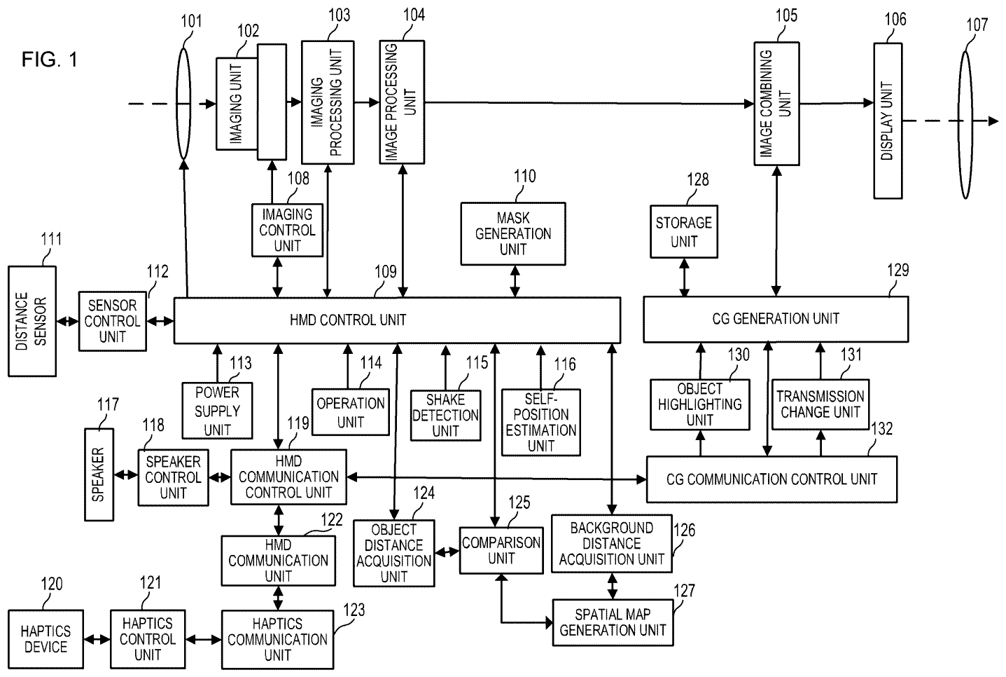

FIG. 1 is a block diagram depicting a configuration of an HMD system according to an embodiment. The HMD system is a head mounted system which displays an image of a real space and a virtual computer graphic (CG) in a superimposed state. Thus the present embodiment can be applied to various HMD systems, including an HMD that can be mounted on the head of the user.

The HMD system includes: a lens unit 101, an imaging unit 102, an imaging processing unit 103, an image processing unit 104, an image combining unit 105, a display unit 106, an eyepiece optical system 107, an imaging control unit 108, and an HMD control unit 109. The HMD system also includes: a mask generation unit 110, a distance sensor 111, a sensor control unit 112, a power supply unit 113, an operation unit 114, a shake detection unit 115, a self-position estimation unit 116, a speaker 117, a speaker control unit 118, and an HMD communication control unit 119. The HMD system also includes: a haptics device 120, a haptics control unit 121, an HMD communication unit 122, a haptics communication unit 123, an object distance acquisition unit 124, a comparison unit 125, a background distance acquisition unit 126, and a spatial map generation unit 127. The HMD system also includes: a storage unit 128, a CG generation unit 129, an object highlighting unit 130, a transmission change unit 131, and a CG communication control unit 132.

The imaging unit 102 captures an image of a real space, including a plurality of objects (e.g. hand of user), via the lens unit 101.

The image (captured image) outputted from the imaging unit 102 is image-processed by the imaging processing unit 103 and the image processing unit 104, and is sent to the image combining unit 105. The image combining unit 105 generates a composite image by combining computer graphics (CG; virtual object) generated by the CG generation unit 129 and the captured image.

The display unit 106 displays the composite image. The composite image is formed on a retina of an eye via the eyepiece optical system 107.

The imaging control unit 108 performs exposure control in the imaging unit 102.

The distance sensor 111 is included in the HMD. The distance sensor 111 captures a distance image indicating distance information under the control of the sensor control unit 112. The distance image indicates a distance between each pixel and an object reflected in this pixel.

The speaker 117 is a device to reproduce the sound under the control of the speaker control unit 118. The haptics device 120 is separate from the HMD. The haptics device 120 is a device which vibrates in accordance with the vibration pattern of haptics (vibration pattern which the haptics communication unit 123 received from the HMD communication unit 122). The haptics device 120 is controlled by the haptics control unit 121.

The power supply unit 113 supplies power in accordance with the intended use of the system. The operation unit 114 is an operation unit which the user uses for operating the HMD system. The operation unit 114 outputs an operation signal to the HMD control unit 109. The shake detection unit 115 detects a shake amount applied to the HMD, and generates a detection signal to indicate the shake amount. The shake detection unit 115 outputs the detection signal to the self-position estimation unit 116, together with the captured image after processing by the image processing unit 104. The self-position estimation unit 116 estimates the self-position of the HMD based on the detection signal to indicate the shake amount and the captured image.

The HMD control unit 109 controls the entire HMD system. The HMD control unit 109 includes a CPU. The HMD control unit 109 communicates with the CG communication control unit 132 via the HMD communication control unit 119.

The object distance acquisition unit 124 acquires a distance from the HMD to the subject based on “a captured image (stereo camera image) acquired from the imaging unit 102” and/or “a distance image acquired from the distance sensor 111”. Specifically, based on the image acquired from the imaging unit 102 or the distance sensor 111, the object distance acquisition unit 124 acquires a distance image that indicates a distance to a specific object (hereafter called “object map”).

The background distance acquisition unit 126 acquires the distance image of the background based on the image acquired from the imaging unit 102 or the distance sensor 111. Based on the distance image of the background acquired by the background distance acquisition unit 126, the spatial map generation unit 127 generates a distance image of the real space, excluding the specific object (hereafter called “spatial map”). Based on the object map and the spatial map, the comparison unit 125 calculates the distance between the specific object and the background.

The mask generation unit 110 generates a mask to extract a CG using the object map. The CG generation unit 129 generates a CG. The CG generation unit 129 also extracts (excludes) the region of the mask from the generated CG using the mask generated by the mask generation unit 110. The extracted CG is combined with the captured image by the image combining unit 105. The image combining unit 105 performs display control so that the display unit 106 displays the MR image including the CG.

The object highlighting unit 130 performs image processing such that the region of the specific object is highlighted in accordance with the distance between the specific object and the background.

The transmission change unit 131 changes the transmittance of the CG in accordance with the distance between the specific object and the background.

The speaker 117 controls the volume of the warning sound in accordance with the distance between the specific object and the background calculated by the comparison unit 125, so as to notify the user of the possibility of contact.

An example of a general operation of the HMD system having this configuration will be described next.

(1) A captured image, capturing the real space including the hand, is acquired by the lens unit 101 and the imaging unit 102. The object distance acquisition unit 124 acquires the distance image of the region of the hand, based on the captured image on the distance image acquired from the distance sensor 111.

(2) The background distance acquisition unit 126 acquires the distance from the HMD to the background based on the captured image or the distance image acquired from the distance sensor 111. The spatial map generation unit 127 generates a spatial map based on the distance image, which indicates the distance from the HMD to the background. The comparison unit 125 compares the distance between the hand and the background. At the same time, the mask generation unit 110 generates a mask image of the hand based on the hand map.

(3) The object highlighting unit 130 and the CG generation unit 129 acquire the mask image of the hand and the information on the distance between the hand and the background. The object highlighting unit 130 performing highlighting processing on the image of the hand in accordance with the distance between the hand and the background. The CG generation unit 129 generates a CG. If a region overlapping with the region of the hand exists in the CG, the CG generation unit 129 excludes this region from the CG.

(4) The image combining unit 105 combines the image of the hand on which the highlighting processing was performed and the CG (CG after the region of the hand is excluded), and generates a composite image. The display unit 106 sends light to the user via the eyepiece optical system 107, whereby the user can perceive the composite image.

By this processing, the region of the hand is highlighted in the display in accordance with the distance between the hand and the background. Thereby a user experience (UX) is implemented, which enables to notify the user of the possibility of contact of the hand and the object by highlighting the region of the hand.

### Embodiment 1

In Embodiment 1, an HMD system which highlights the region of the hand in the display in accordance with the distance between the hand and the object will be described. The HMD system may be an arbitrary electronic apparatus (device), such as an HMD, a digital camera and a smartphone.

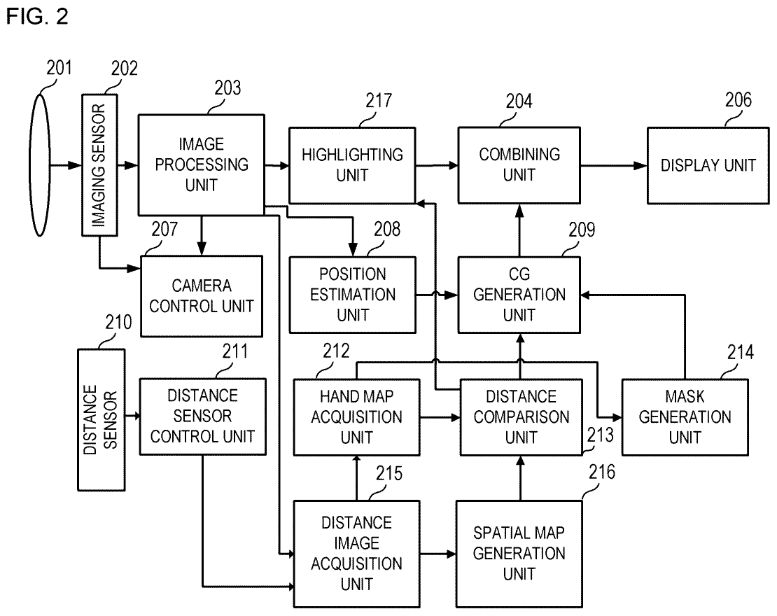

FIG. 2 indicates a configuration of the HMD according to Embodiment 1. FIG. 2 is a diagram indicating the configuration particularly related to Embodiment 1 from the HMD system indicated in FIG. 1.

The HMD system includes: an optical system 201, an imaging sensor 202, an image processing unit 203, a combining unit 204, a display unit 206, a camera control unit 207, a position estimation unit 208, a CG generation unit 209, and a distance sensor 210. The HMD system also includes: a distance sensor control unit 211, a hand map acquisition unit 212, a distance comparison unit 213, a mask generation unit 214, a distance image acquisition unit 215, a spatial map generation unit 216, and a highlighting unit 217.

The optical system 201 includes the lens unit 101.

The imaging sensor 202 acquires a captured image by imaging a real space including a plurality of objects, such as a hand of the user. The imaging sensor 202 corresponds to the imaging unit 102.

The image processing unit 203 performs image processing on the captured image acquired by the imaging sensor 202. The image processing unit 203 corresponds to the imaging processing unit 103 and the image processing unit 104.

The camera control unit 207 controls the imaging sensor 202. The camera control unit 207 corresponds to the imaging control unit 108.

The position estimation unit 208 estimates the position of the imaging sensor 202 (HMD) based on the captured image. The position estimation unit 208 corresponds to the shake detection unit 115 and the self-position estimation unit 116.

The distance sensor 210 acquires a distance image by imaging a subject. The distance sensor 210 corresponds to the distance sensor 111.

The distance sensor control unit 211 controls the distance sensor 210. The distance sensor control unit 211 corresponds to the sensor control unit 112.

The distance image acquisition unit 215 converts the captured image into the distance image, or the distance image acquisition unit 215 acquires the distance image from the distance sensor 210. The distance image acquisition unit 215 may also correct the distance image acquired from the distance sensor 210 based on the captured image. In the following, the distance image acquired by the distance image acquisition unit 215 is called a “general distance image”.

The hand map acquisition unit 212 acquires an image indicating the distance information on the region of the hand (hereafter called a “hand map”) based on the general distance image. The hand map acquisition unit 212 corresponds to the object distance acquisition unit 124.

The spatial map generation unit 216 acquires a spatial map, as an image indicating the distance information on the real space, excluding the hand, based on the general distance information. The spatial map generation unit 216 corresponds to the spatial map generation unit 127.

The distance comparison unit 213 calculates the distance between the hand and an object (object existing in the real space) based on the hand map and the spatial map. The distance comparison unit 213 may calculate the distance between the hand and the object by a method other than the method based on the hand map and the spatial map. The distance comparison unit 213 may calculate the distance between the hand and the object based on a plurality of captured images, which were captured from different viewpoints. The distance comparison unit 213 corresponds to the comparison unit 125.

The mask generation unit 214 generates a mask of the region of the hand based on the hand map. The mask generation unit 214 corresponds to the mask generation unit 110.

The CG generation unit 209 generates a CG (virtual object) based on the position of the HMD estimated by the position estimation unit 208. If it is determined that the region of the hand overlaps with the CG based on the mask of the region of the hand, the CG generation unit 209 removes the range corresponding to the region of the hand from the CG. The CG generation unit 209 corresponds to the CG generation unit 129.

The highlighting unit 217 controls the highlighting degree of the region of the hand in accordance with the distance between the hand and the object (distance calculated by the distance comparison unit 213). The highlighting unit 217 corresponds to the object highlighting unit 130.

The combining unit 204 combines the “CG” and the “image of hand on which the highlighting processing was performed”, and generates a composite image thereof. The combining unit 204 corresponds to the image combining unit 105.

The display unit 206 displays the composite image. Thereby the display unit 206 can display the image of the hand highlighted in the display in accordance with the distance between the hand and the background. Hence the display unit 206 can notify the user of the possibility of contact of a “real object behind the CG” and the “hand”. The display unit 206 corresponds to the display unit 106.

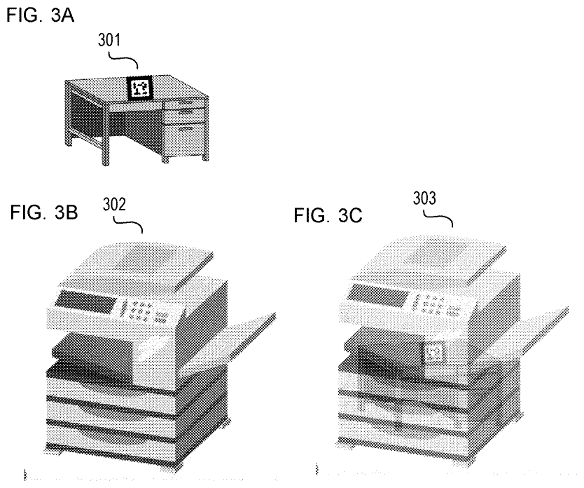

FIG. 3C is a diagram depicting an image 303 where a printer 302 of a CG in FIG. 3B is superimposed on a real desk 301 in FIG. 3A. An AR marker is disposed in advance on the real desk 301. In MR, the printer of the CG is disposed on the AR marker, as if the printer of the CG is able to be touched by hand.

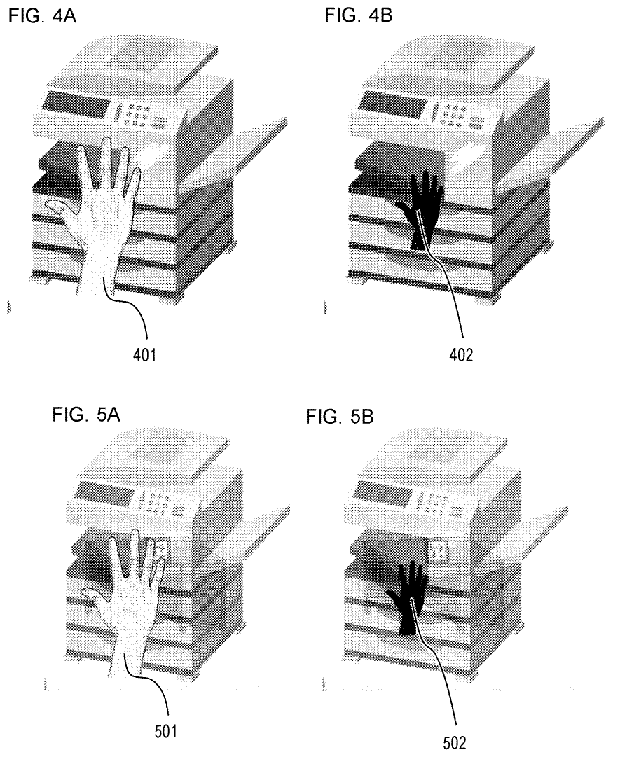

FIGS. 4A and 4B are diagrams depicting a function to touch the “printer of CG superimposed and displayed on the real desk” indicated in FIG. 3C, with the real hand of the user. In FIG. 4B, the region of the hand is highlighted in the display in accordance with the distance between the real hand and the real desk hidden behind the CG, so as to notify the user of the possibility of contact. In FIG. 4A, a hand 401 is located slightly distant from the real desk located on the back side of the printer of the CG, hence the hand 401 is not highlighted. In FIG. 4B, on the other hand, a hand 402 is located near the real desk which is on the back side of the printer of the CG, hence the hand 402 is highlighted. In this way, the user can roughly recognize the distance between the real desk on the back side of the CG and the hand, by the degree of highlighting of the region of the real hand. Therefore the user can have an excellent MR experience using UX.

FIGS. 5A and 5B are diagrams visualizing the real desk which is located on the back side of the CG. In FIG. 5A, the hand 501 is located slightly distant from the real desk which is located on the back side of the printer of the CG, hence the hand 501 is not highlighted. In FIG. 5B, a hand 502 is located near the real desk which is located on the back side of the printer of the CG, hence the hand 502 is highlighted.

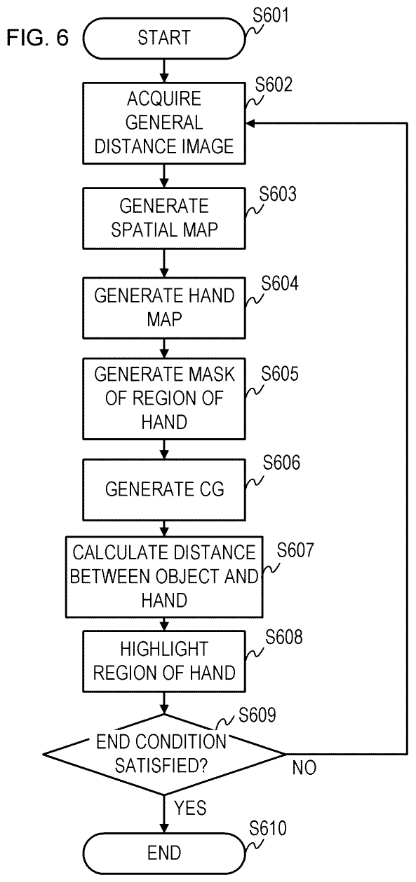

The highlighting processing of the region of the hand according to Embodiment 1 will be described with reference to the flow chart in FIG. 6. The following is a case based on the assumption that the hand and the CG (virtual object) are superimposed in the composite image (space expressed by the composite image). However the processing in the flow chart in FIG. 6 may also be executed for the other cases (e.g. a case where the distance between the hand and the CG is shorter than a predetermined distance). Further, unless the hand and the CG (virtual object) are superimposed in the composite image (space expressed by the composite image), the highlighting processing of the region of the hand need not be performed. This flow chart starts with step S601.

In step S602, the distance image acquisition unit 215 acquires the general distance image based on the captured image acquired by the imaging sensor 202, or the distance image acquisition unit 215 acquires the general distance image based on the distance image acquired by the distance sensor 210.

In step S603, the spatial map generation unit 216 generates a spatial map which indicates distance information of the real space, not including the hand, based on the general distance image.

In step S604, the hand map acquisition unit 212 generates a hand map based on the general distance image.

In step S605, the mask generation unit 214 generates a mask of the region of the hand.

In step S606, the CG generation unit 209 generates a CG. Then using the mask of the region of the hand, the CG generation unit 209 removes the region of the mask from the CG, or the CG generation unit 209 makes the region of the mask transparent in the CG.

In step S607, the distance comparison unit 213 calculates the distance between a real object (e.g. an object which is located on the back side of (behind) the hand, and is closest to the hand among a plurality of objects) and the hand, based on the spatial map and the hand map.

In step S608, the highlighting unit 217 controls highlighting of the region of the hand in the display in accordance with the distance from the hand to the real object. “To control highlighting of the region of the hand” may be interpreted as “to control the display format of the region of the hand in accordance with the distance from the hand to the real object”. For example, as the distance from the hand to the real object is shorter, the highlighting unit 217 increases the brightness of the region of the hand, or makes the color of the region of the hand closer to a specific color, or increases the size of the region of the hand.

The processing in step S608 may be executed in a space indicated by the composite image (MR space) only when the CG is superimposed on the front side of the real object. In the case where at least a part of the real object is displayed on the composite image, the highlighting unit 217 need not execute “control of highlighting of the region of the hand in accordance with the distance from the hand to the real object”. In this case, the user can estimate the positional relationship between the hand and the real object by viewing the composite image, hence the necessity of highlighting decreases. Further, not highlighting can improve the sense of immersion of the user in MR.

In step S609, the highlighting unit 217 determines whether the end conditions are satisfied. Processing returns to step S602 if it is determined that the end conditions are not satisfied. Processing in this flow chart ends in step S610 if it is determined that the end conditions are satisfied. When the processing in this flow chart ends, a composite image, combining the CG and the captured image (captured image on which degree of highlighting the region of the head was controlled) is generated by the combining unit 204, and the composite image is displayed on the display unit 206.

According to Embodiment 1, the HMD system highlights the hand in the display in accordance with the distance between the “real hand” and the “real object located on the back side of the CG”. Thereby the HMD system can warn the user so that the hand of the user does not contact with the real object hidden behind the CG. In Embodiment 1, by changing the transmittance of CG or by emitting a warning sound to the user, it becomes unnecessary to use a method to diminish the sense of immersion or to interrupt an operation. Therefore the user can be provided with excellent UX, which allows the user to experience the hand mask function by MR.

### Embodiment 2

In Embodiment 1, the degree of highlighting of the hand in the display is controlled in accordance with the distance between the hand and the object. However instead of the hand, an arbitrary object that the user can freely move may be used. Therefore in Embodiment 2, the HMD system performs highlighting processing of a region of a specific object in accordance with a distance between a “specific object (a part of the body or operation member)” and an “object other than the specific object”. Hereafter the “object other than the specific object” is called a “general object”.

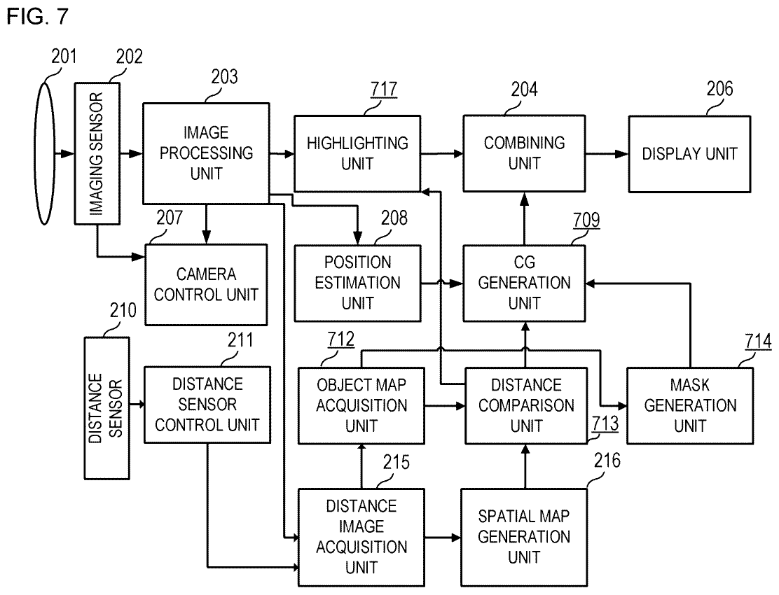

FIG. 7 indicates a block diagram of the HMD system according to Embodiment 2. The HMD system includes: the optical system 201, the imaging sensor 202, the image processing unit 203, the combining unit 204, the display unit 206, the camera control unit 207, the position estimation unit 208, a CG generation unit 709, and the distance sensor 210. The HMD system also includes: the distance sensor control unit 211, an object map acquisition unit 712, a distance comparison unit 713, a mask generation unit 714, the distance image acquisition unit 215, the spatial map generation unit 216, and a highlighting unit 717. In this configuration, the description on the composing elements indicated in FIG. 2 will be omitted, since the same processing described in Embodiment 1 is performed.

The object map acquisition unit 712 acquires an image indicating the distance information on the region of the specific object (hereafter called “object map”) based on the general distance image acquired by the distance image acquisition unit 215. The specific object may be an object which the user specified in advance, or an object closest to the hand of the user.

The distance comparison unit 713 compares the distance between the specific object and a general object (e.g. background) based on the object map and the spatial map.

The mask generation unit 714 generates a mask of the region of the specific object based on the object map.

The CG generation unit 709 generates a CG based on the position of the HMD estimated by the position estimation unit 208. If it is determined that the CG overlaps with the region of the specific object based on the mask of the region of the specific object, the CG generation unit 709 removes the range corresponding to the region of the specific object from the CG.

The highlighting unit 717 controls the degree of highlighting the region of the specific object in accordance with the distance between the specific object and a general object (distance calculated by the distance comparison unit 713).

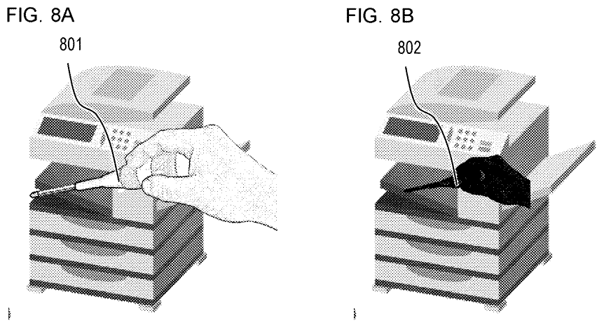

FIGS. 8A and 8B are diagrams describing a function of touching the printer of the CG, displayed superimposed on the real desk, using such an operation member as a driver (specific object). FIGS. 8A and 8B are related to UI to notify the user of the possibility of contact by highlighting the region of the operation member in the display in accordance with the distance between the “real operation member (e.g. driver)” and the “real desk hidden behind the CG”.

In FIG. 8A, an operation member 801 is located slightly distant from the real desk located on the back side of the printer of the CG, hence the operation member 801 is not highlighted. In FIG. 8B, on the other hand, an operation member 802 is located near the real desk located on the back side of the printer of the CG, hence the operation member 802 is highlighted. In this way, the user can recognize a general distance between the real desk located on the back side of the CG and the operation member by the degree of highlighting of the region of the real operation member.

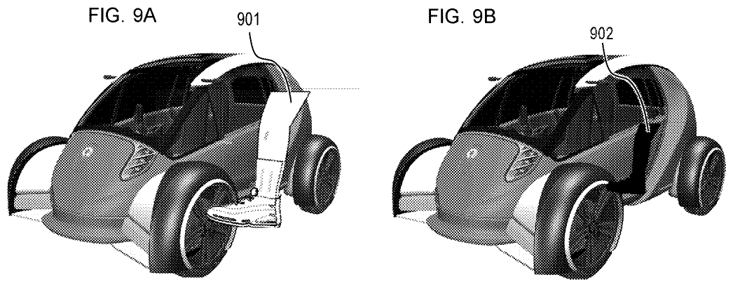

FIGS. 9A and 9B are diagrams describing a function of providing an experience of sitting on a seat of a car of a CG displayed superimposed on a real seat. In the state described in FIGS. 9A and 9B, a real leg (a part of the body) is handled as the specific object, and the region of the leg is highlighted in the display in accordance with the distance between the “real seat hidden behind the CG” and the “real leg”.

In FIG. 9A, a leg 901 is located slightly distant from the real seat located on the back side of the car of the CG, hence the leg 901 is not highlighted. In FIG. 9B, on the other hand, a leg 902 is located near the real seat located on the back side of the car of the CG, hence the leg 902 is highlighted. In this way, the user can recognize a general distance between the real seat located on the back side of the CG and the leg by the degree of highlighting of the region of the real leg.

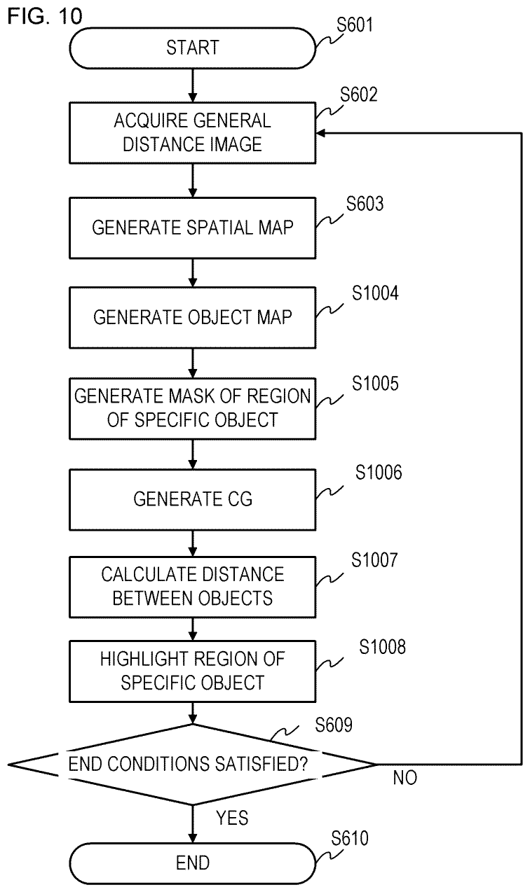

The processing according to Embodiment 2 will be described with reference to the flow chart in FIG. 10. In FIG. 10, a step denoted with a same reference sign as the flow chart in FIG. 6 is a step of executing a same processing as the flow chart in FIG. 6, hence description thereof will be omitted.

In step S1004, the object map acquisition unit 712 generates an object map based on the general distance image.

In step S1005, the mask generation unit 714 generates a mask of a region of a specific object.

In step S1006, the CG generation unit 709 generates a CG. Using the mask of the region of the specific object, the CG generation unit 709 removes the range corresponding to the region of the specific object, from the CG.

In step S1007, the distance comparison unit 713 calculates the distance between the specific object and a real object (general object) closest to the specific object, based on the spatial map and the object map.

In step S1008, the highlighting unit 717 controls highlighting of the region of the specific object in accordance with the distance calculated by the distance comparison unit 713. For example, as the distance from the specific object to the general object is shorter, the highlighting unit 717 increasingly highlights the specific object so that the user can easily recognize the specific object. Specifically, as the distance from the specific object to the general object is shorter, the highlighting unit 717 makes the region of the specific object brighter or larger. The processing in step S1008 may be executed only in a case where the CG is superimposed on the front side of the general object in the space (MR space) expressed by the composite image.

According to Embodiment 2, the HMD system highlights the specific object in the display in accordance with the distance between the “specific object (a part of the operation member or a part of the body)” and “another object located on the back side of the CG”. Thereby the HMD system can warn the user so that the real object hidden behind the CG does not contact with the specific object. By changing the transmittance of the CG or by emitting a warning sound to the user, the HMD system does not use a method to diminish the sense of immersion or to interrupt an operation. Therefore the user can be provided with an excellent UX which allows the user to experience the hand mask function by MR.

### Embodiment 3

In Embodiment 3, in the case where the hand is located on the front side of the CG, the HMD system highlights the region of the hand in the display. In the case where the hand is located on the back side of the CG and the hand is not visible, the HMD system does not highlight the hand in the display. In this case, the HMD system changes the intensity of vibration of the haptics device in accordance with the distance, or changes the volume of the warning sound in accordance with the distance, or changes the transmittance of the CG in accordance with the distance.

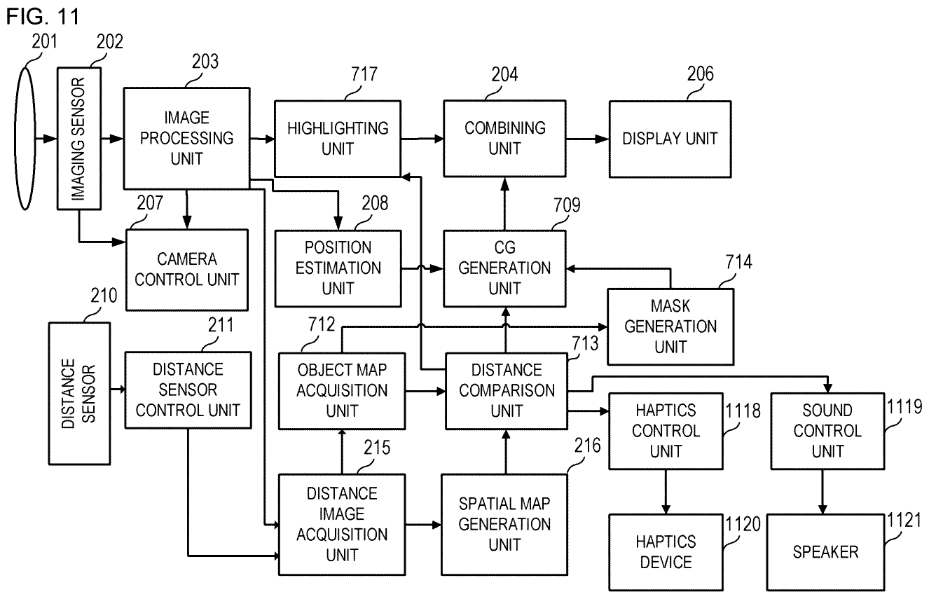

FIG. 11 indicates a block diagram of the HMD system according to Embodiment 3. The HMD system according to Embodiment 3 includes a haptics control unit 1118, a sound control unit 1119, a haptics device 1120, and a speaker 1121, in addition to the configuration of the HMD system in FIG. 7. These additional components execute the processing to notify the possibility of contact in a case where the specific object is not displayed in the composite image, because the specific object is located on the back side of the CG. The haptics device 1120, the speaker 1121 and the display unit 206 are configured to notify the user of the possibility of contact, hence these composing elements may be collectively called a “notification unit”. In the following, three examples of processing to notify the possibility of contact, executed by the haptics device 1120, the speaker 1121 and the display unit 206 will be described.

For a first example (Example 1), the haptics control unit 1118 selects a control pattern of the haptics intensity (vibration intensity) in accordance with the distance between the specific object and a general object. The haptics device 1120 performs vibration in accordance with the selected control pattern, so as to notify the user of the possibility of contact between the specific object and the general object behind the CG.

For a second example (Example 2), the sound control unit 1119 selects a volume of the output of the speaker 1121 in accordance with the distance between the specific object and a general object. The speaker 1121 emits sound in accordance with the selected volume of the output, so as to notify the user of the possibility of contact between the specific object and the general object behind the CG.

For a third example (Example 3), the CG generation unit 709 changes the transmittance of the CG in accordance with the distance between the specific object and a general object. The combining unit 204 generates a composite image using the CG of which transmittance was changed. The display unit 206 displays the composite image using the CG of which transmittance was changed, so as to notify the user of the possibility of contact between the specific object and the general object behind the CG.

In the case where the specific object (e.g. hand) is located on the front side of the CG like this, the specific object is highlighted. On the other hand, in the case where the specific object (e.g. hand) is located on the back side of the CG, haptics intensity, volume or transmittance of the CG is changed. Thereby even if the hand or the like is hidden by the CG and is invisible, the user can be notified of the possibility of contact with the real object located on the back side of the CG.

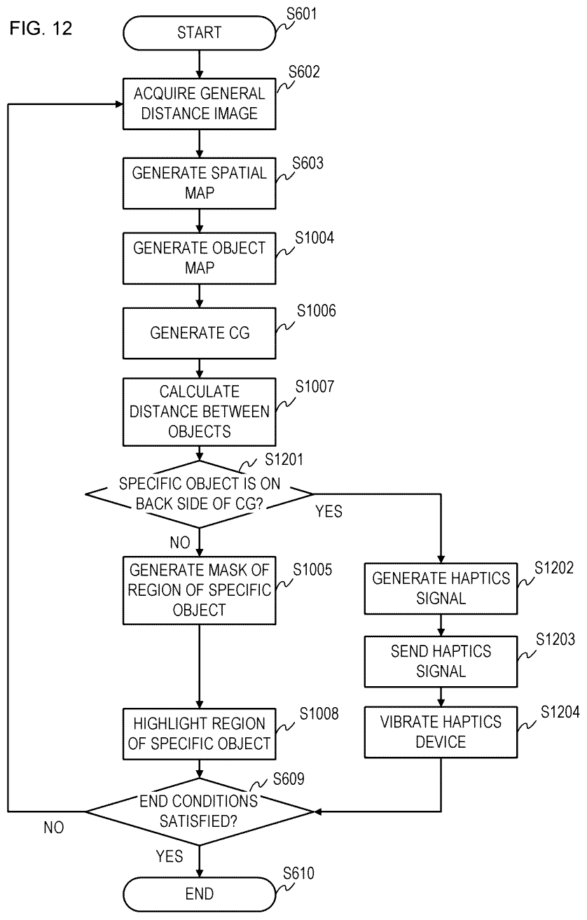

The processing according to Embodiment 3 in the case of the above mentioned Example 1 will be described with reference to the flow chart in FIG. 12. In FIG. 12, a step denoted with a same reference sign as the flow chart in FIG. 10 is a step of executing a same processing as Embodiment 2, hence description thereof will be omitted.

In step S1201, the distance comparison unit 713 determines whether the specific object is hidden behind the CG (specific object is located on the back side of the CG). Processing advances to step S1202 if it is determined that the specific object is hidden behind the CG. Processing advances to step S1005 if it is determined that the specific object is not hidden behind the CG.

In step S1202, the haptics control unit 1118 generates a haptics signal, which indicates the vibration intensity in accordance with the distance calculated by the distance comparison unit 713. Specifically, the haptics control unit 1118 increases the vibration intensity indicated by the haptics signal as the distance calculated by the distance comparison unit 713 is shorter, for example.

In step S1203, the haptics control unit 1118 sends the generated haptics signal to the haptics device 1120.

In step S1204, the haptics device 1120 vibrates at a vibration intensity in accordance with the received haptics signal.

The processing according to Embodiment 3 in the case of the above mentioned Example 2 will be described with reference to the flow chart in FIG. 13. In FIG. 13, a step denoted with a same reference sign as the flow chart in FIG. 10 is a step of executing a same processing as Embodiment 2, hence description thereof will be omitted.

In step S1301, the distance comparison unit 713 determines whether the specific object is hidden behind the CG (specific object is located on the back side of the CG). Processing advances to step S1302 if it is determined that the specific object is hidden behind the CG. Processing advances to step S1005 if it is determined that the specific object is not hidden behind the CG.

In step S1302, the sound control unit 1119 generates a tone signal, which indicates the volume in accordance with the distance calculated by the distance comparison unit 713. Specifically, the sound control unit 1119 increases the volume indicated by the tone signal as the distance calculated by the distance comparison unit 713 is shorter, for example.

In step S1303, the sound control unit 1119 sends the generated tone signal to the speaker 1121.

In step S1304, the speaker 1121 outputs a tone (sound) indicating a warning with volume in accordance with the received tone signal.

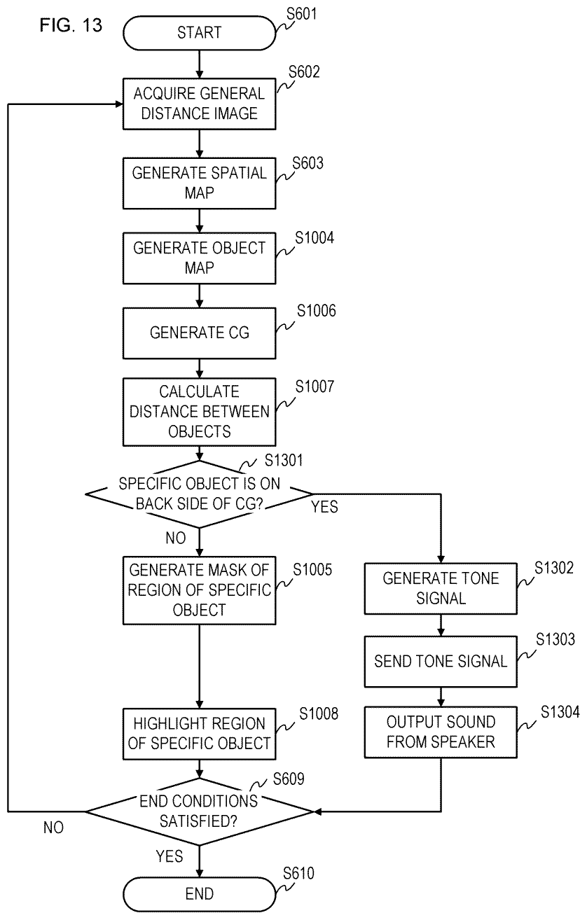

The processing according to Example 3 in the case of the above mentioned Example 3 will be described with reference to the flow chart in FIG. 14. In FIG. 14, a step denoted with a same reference sign as the flow chart in FIG. 10 is a step of executing a same processing as Embodiment 2, hence the description thereof will be omitted.

In step S1401, the distance comparison unit 713 determines whether the predetermined object is hidden behind the CG (specific object is located on the back side of the CG). Processing advances to step S1402 if it is determined that the specific object is hidden behind the CG. Processing advances to step S1005 if it is determined that the specific object is not hidden behind the CG.

In step S1402, the CG generation unit 709 controls the transmittance of the generated CG in accordance with the distance calculated by the distance comparison unit 713. Specifically, the CG generation unit 709 increases the transmittance of the CG as the distance calculated by the distance comparison unit 713 is shorter, for example.

In step S1403, the CG generation unit 709 sends the CG, of which transmittance was controlled, to the combining unit 204.

In step S1404, the combining unit 204 generates a composite image by combining the CG, of which transmittance was controlled, and the captured image.

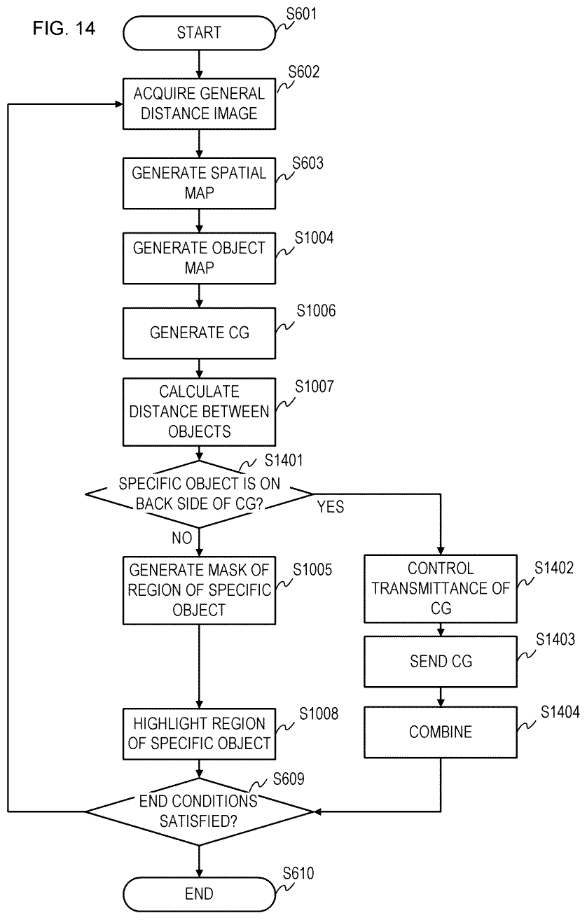

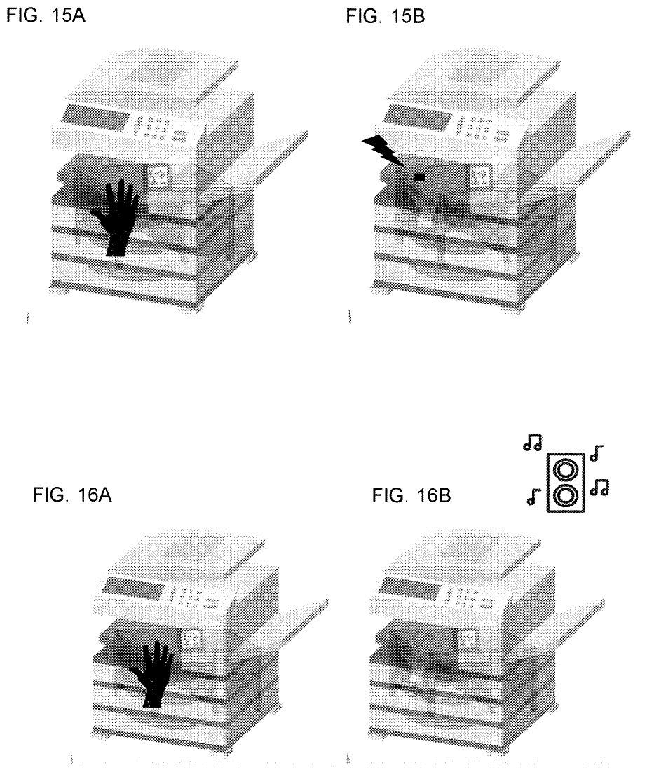

In FIG. 15A, the hand is located on the front side of the CG, hence the region of the hand is highlighted in the display in accordance with the distance between the hand and the “real desk behind the CG”. In FIG. 15B, the hand is located on the back side of the CG, hence the vibration intensity of the haptics device 1120 worn on a finger is changed in accordance with the distance between the hand and the “real desk behind the CG”. Thereby as indicated in FIG. 15B, the user can intuitively recognize the distance between the hand hidden behind the CG and the real desk, even if the hand is hidden behind the CG.

In FIG. 16A, the hand is located on the front side of the CG, hence the region of the hand is highlighted in the display in accordance with the distance between the hand and the “real desk behind the CG”. In FIG. 16B, the hand is located on the back side of the CG, hence the volume of the warning sound from the speaker 1121 is changed in accordance with the distance between the hand and the “real desk behind the CG”. Thereby as indicated in FIG. 16B, the user can intuitively recognize the distance between the hand hidden behind the CG and the real desk, even if the hand is hidden behind the CG.

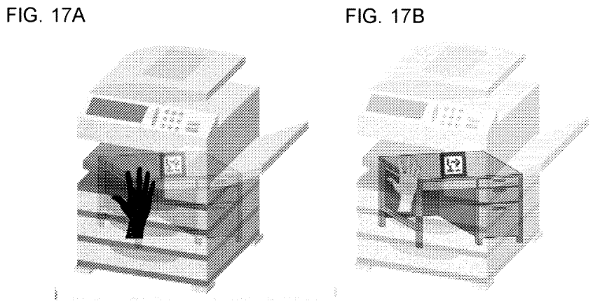

In FIG. 17A, the hand is located on the front side of the CG, hence the region of the hand is highlighted in the display in accordance with the distance between the hand and the “real desk behind the CG”. In FIG. 17B, the hand is located on the back side of the CG, hence the transmittance of the CG is changed in accordance with the distance between the hand and the “real desk behind the CG”. Thereby as indicated in FIG. 17B, the user can intuitively recognize the distance between the hand hidden behind the CG and the real desk, even if the hand is hidden behind the CG.

According to Embodiment 3, the HMD system does not highlight the specific object in the display if the specific object is located on the back side of the CG, and is invisible. In this case, the HMD system uses the method of changing the vibration intensity of the haptics device in accordance with the distance between the specific object and the general object, the method of changing the volume of the warning sound in accordance with this distance, or the method of changing the transmittance of the CG in accordance with this distance. Thereby the user can recognize the distance between the specific object and another object, even if the specific object is hidden behind the CG. Hence the user can avoid contact of the specific object with another object.

According to the present invention, in the MR technique, a technique for enabling appropriately to notify the user the possibility of contact can be provided.

In the above description, “processing advances to step S1 if A is B or more, or advances to step S2 if A is smaller (lower) than B” may be interpreted as “processing advances to step S1 if A is larger (higher) than B, or advances to step S2 if A is B or less”. Conversely, “processing advances to step S1 if A is larger (higher) than B, or advances to step S2 if A is B or less” may be interpreted as “processing advances to step S1 if A is B or more, or advances to step S2 if A is smaller (lower) than B”. Therefore as long as no inconsistency is generated, “A or more” may be interpreted as “larger (higher; longer; more) than A”, and “A or less” may be interpreted as “smaller (lower; shorter; less) than A”. Further, “larger (higher; longer; more) than A” may be interpreted as “A or more”, and “smaller (lower; shorter; less) than A” may be interpreted as “A or less”.

The various above mentioned controls may or may not be performed by one hardware device (e.g. processor or circuit). A plurality of hardware devices (e.g. a plurality of processors, a plurality of circuits or a combination of one or more processors and one or more circuits) may share the processing to control the entire apparatus.

The above mentioned processor is a processor in a wide sense, and includes a general purpose processor and a dedicated processor. The general purpose processor is, for example, a central processing unit (CPU), a micro processing unit (MPU), a digital signal processor (DSP), or the like. The dedicated processor is, for example, a graphics processing unit (GPU), an application specific integrated circuit (ASIC), a programmable logic device (PLD), or the like. The programmable logic device is, for example, a field programmable gate array (FPGA), a complex programmable logic device (CPLD), or the like.

Whereas embodiments of the present invention have been described, the present invention is not limited to these specific embodiments, but also include various modes in a range not departing from the spirit of the invention. Further, each of the above embodiments is merely an example of the present invention, and each embodiment may be appropriately combined.

In the above mentioned embodiments, a case of applying the present invention to the HMD system (HMD) was described as example, but the present invention is not limited to these examples, and is applicable to any electronic apparatus or information processing apparatus (information processing system) which can execute image processing on a captured image. The electronic apparatus or the information processing apparatus (information processing system) may be a computer, a smartphone, a tablet terminal, a digital camera or home electronic equipment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-042166, filed on Mar. 18, 2024, which is hereby incorporated by reference herein in its entirety.

What is claimed is:

1. An information processing apparatus comprising one or more processors and/or circuitry configured to:
execute acquisition processing to acquire a captured image capturing a real space including a first object and a second object;
execute generation processing to generate a virtual object;
execute combining processing to generate a composite image by combining the captured image and the virtual object;
execute display control processing to control a display such that the composite image is displayed; and
execute notification processing to perform notification to a user in accordance with a distance between the first object and the second object in a first case where the virtual object is superimposed on a front side of the second object in a space expressed by the composite image.

2. The information processing apparatus according to claim 1, wherein
out of a plurality of objects in the real space, the second object is an object located behind the first object and is closest to the first object.

3. The information processing apparatus according to claim 1, wherein
in the first case in the notification processing, the notification is performed by controlling highlighting of display of the first object in accordance with the distance between the first object and the second object.

4. The information processing apparatus according to claim 3, wherein
in the first case in the notification processing, display of the first object is increasingly highlighted as the distance between the first object and the second object is shorter.

5. The information processing apparatus according to claim 1, wherein
in the first case in the notification processing, the notification is performed by controlling vibration intensity of a first device in accordance with the distance between the first object and the second object.

6. The information processing apparatus according to claim 1, wherein
in the first case in the notification processing, the notification is performed by controlling volume of a warning sound emitted from a second device in accordance with the distance between the first object and the second object.

7. The information processing apparatus according to claim 1, wherein
in the first case in the notification processing, the notification is performed by controlling transmittance of the virtual object in accordance with the distance between the first object and the second object.

8. The information processing apparatus according to claim 1, wherein the first object is a part of a body.

9. The information processing apparatus according to claim 8, wherein the first object is a hand.

10. The information processing apparatus according to claim 1, wherein the first object is a part of an operation member.

11. The information processing apparatus according to claim 1, wherein
in the first case in the notification processing,
the notification is performed by controlling highlighting of display of the first object in accordance with the distance between the first object and the second object, in a second case where the first object is superimposed on the front side of the virtual object in a space expressed by the composite image, and
the notification in accordance with the distance between the first object and the second object is performed using a method other than the method of controlling highlighting of display of the first object, in a third case where the virtual object is superimposed on the front side of the first object in the space expressed by the composite image.

12. The information processing apparatus according to claim 11, wherein
in the third case in the notification processing, vibration intensity of a first device, volume of a warning sound emitted from a second device, or transmittance of the virtual object is controlled in accordance with the distance between the first object and the second object.

13. An information processing method, comprising:
an acquisition step of acquiring a captured image capturing a real space including a first object and a second object;
a generation step of generating a virtual object;
a combining step of generating a composite image by combining the captured image and the virtual object;
a display control step of controlling a display such that the composite image is displayed; and
a notification step of performing notification to a user in accordance with a distance between the first object and the second object in a first case where the virtual object is superimposed on a front side of the second object in a space expressed by the composite image.

14. A non-transitory computer readable medium that stores a program, wherein the program causes a computer to execute an information processing method, the information processing method, comprising:
an acquisition step of acquiring a captured image capturing a real space including a first object and a second object;
a generation step of generating a virtual object;
a combining step of generating a composite image by combining the captured image and the virtual object;
a display control step of controlling a display such that the composite image is displayed; and
a notification step of performing notification to a user in accordance with a distance between the first object and the second object in a first case where the virtual object is superimposed on a front side of the second object in a space expressed by the composite image.
